(19) United States
(12) Patent Application Publication
(10) Pub. No.: US 2014/0278459 A1
(43) Pub. Date: Sep. 18, 2014

(54) APPARATUSES, SYSTEMS, AND METHODS FOR PROVIDING ACTION PLANS TO IMPROVE HEALTH CARE PROVIDER PERFORMANCE

(71) Applicant: MCKESSON FINANCIAL HOLDINGS, Hamilton (BM)

(72) Inventor: Brian Morris, Lawrenceville, GA (US)

(73) Assignee: MCKESSON FINANCIAL HOLDINGS, Hamilton (BM)

(21) Appl. No.: 13/832,692

(22) Filed: Mar. 15, 2013

(51) Int. Cl. G06Q 10/06; G06Q 50/22

(52) U.S. Cl. CPC G06Q 10/06393; G06Q 50/22
USPC 705/2

(57) ABSTRACT

Apparatuses and methods are provided that can acquire benchmarking data regarding a particular performance metric, compare a pharmacy's performance with the performance of other pharmacies using the benchmarking data, and recommend action plans aimed at improving the pharmacy's performance. The action plans may be customized for the particular pharmacy, so as to provide the pharmacy with a detailed, pharmacy-specific recommendation for improving performance in one or more targeted areas.

### BACKGROUND

Health care providers, including pharmacies/pharmacists, physicians' offices, nursing homes, dentists, hospitals, and the like, are constantly under pressure to provide quality products and services to their customers, while at the same time increasing their profit margins. As the cost of health care increases, it becomes more difficult for some health care providers to operate in a profitable manner and to provide increasing quality.

At the same time, competition in the health care industry is growing, which in some cases means that a number of health care providers are attempting to attract the business of a limited number of customers. There is also growing demand for greater attention to patient privacy, business transparency, and systems interoperability throughout the health care industry.

Accordingly, there is a need in the art for techniques for assisting health care providers to meet these numerous and varied demands.

### BRIEF SUMMARY OF THE INVENTION

Embodiments of the present invention address, among other things, the above need by providing improved apparatuses, systems, and methods for facilitating the acquisition and analysis of benchmarking data and recommending action plans designed to improve the overall performance of health care providers, while respecting and promoting the demands of patient privacy, business transparency and systems interoperability. Demand is especially great where these action plans can be systematically automated to allow health care providers to spend more of their time with patients instead of spending more of their time on administration.

Accordingly, an apparatus for providing action plans for improving health care provider performance is provided, where the apparatus comprises at least one processor and at least one memory including computer program code. The at least one memory and the computer program code may be configured to, with the processor, cause the apparatus to at least receive selection from a user of one of a plurality of predefined performance metrics, analyze performance of a health care provider with respect to benchmarking data for the metric selected, and provide for presentation to the user of a recommended action plan based on the metric selected and the performance of the health care provider.

In some cases, the at least one memory and the computer program code may be further configured to, with the processor, cause the apparatus to provide for presentation to the user of the recommended action plan by providing for presentation to the user of a plurality of predefined action plans based on the metric selected, wherein the at least one memory and the computer program code are further configured to, with the processor, cause the apparatus to receive selection from the user of one of the predefined action plans for execution. The at least one memory and the computer program code may be further configured to, with the processor, cause the apparatus to customize the action plan for the health care provider.

The at least one memory and the computer program code may be further configured to, with the processor, cause the apparatus to receive an indication of acceptance of the action plan from the user and to execute the action plan in response to receipt of the indication. The at least one memory and the computer program code may be further configured to, with the processor, cause the apparatus to receive selection from the user of a benchmarking location grouping, and to access benchmarking data for analysis based at least partially on the benchmarking location grouping selected. In some cases, the at least one memory and the computer program code may be further configured to, with the processor, cause the apparatus to access the benchmarking data from at least one third party source.

Additionally or alternatively, the at least one memory and the computer program code may be further configured to, with the processor, cause the apparatus to monitor the performance of the health care provider for the metric selected over a predefined period of time. The analysis of the performance of the health care provider with respect to benchmarking data occurs in real time.

In still other embodiments, a method and a computer program product for improving health care provider performance are provided. The method and computer program product include receiving selection from a user of one of a plurality of predefined performance metrics; analyzing performance of a health care provider with respect to benchmarking data for the metric selected; and providing for presentation to the user of a recommended action plan based on the metric selected and performance of the health care provider.

In some cases, providing for presentation to the user of the recommended action plan may comprise providing for presentation to the user of a plurality of predefined action plans based on the metric selected, and the method may further include receiving selection from the user of one of the predefined action plans for execution. The action plan may be customized for the health care provider.

An indication of acceptance of the action plan may be received from the user and the action plan may be executed in response to receipt of the indication. The method and computer program product may further include receiving selection from the user of a benchmarking location grouping and accessing benchmarking data for analysis based at least partially on the benchmarking location grouping selected. The benchmarking data may be accessed from at least one third party source.

In some embodiments, the performance of the health care provider may be monitored for the metric selected over a predefined period of time. The analysis of the performance of the health care provider with respect to benchmarking data may occur in real time.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic diagram of interaction between an application server and various system components in accordance with one exemplary embodiment;

FIG. 2 is a schematic representation of an apparatus in accordance with one exemplary embodiment of the present invention;

FIG. 3 illustrates a user interface for selecting a benchmarking location grouping in accordance with one exemplary embodiment of the present invention;

FIG. 4A illustrates a user interface for selecting a performance metric in accordance with one exemplary embodiment of the present invention;

FIG. 4B illustrates an example of a report providing a user with benchmarking data for a particular performance metric in accordance with one exemplary embodiment of the present invention;

FIGS. 5A and 5B illustrate user interfaces for selecting an action plan in accordance with exemplary embodiments of the present invention; and

FIG. 6 is a flow chart illustrating a method of providing action plans for improving health care provider performance according to an exemplary embodiment of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

Although the description that follows includes examples in which embodiments of the invention are used in the context of pharmacies for ease of explanation, it is understood that embodiments of the invention may benefit and improve the performance of various types of health care providers, including pharmacies, clinics, hospitals, medical groups, and others.

Health care providers, such as pharmacies, face increasing competition and are constantly dealing with pressure to optimize profit margins. An independent pharmacy, for example, may find itself competing, not only with other independent pharmacies, but also with big box stores that have in-store pharmacy departments. It may not be enough for the independent pharmacy in this example to analyze only its own expenses and revenues. This is because, although the pharmacy may be maintaining a constant stream of revenue and may not have increased its operating expenses, other pharmacies may be reducing their operating expenses and/or increasing their revenues (e.g., by attracting new customers). Thus, without considering how others are performing, the pharmacy in this example may not have a good perspective on how it can improve its own performance to maximize its profits.

To properly benchmark its performance against the performance of others, a business should have access to information about those other businesses. In the context of pharmacies, for example, advances in technology are making more and more data available about how pharmacies are operating. Health care transactions are becoming more standardized and modernized, allowing for comparable data to be gathered for similar transactions across different pharmacies. In addition, advances in submitting and processing pharmacy claims and electronic prescriptions are providing automated and automatic processes for collecting data regarding typical pharmacy activities, such as data regarding receiving prescriptions, filling prescriptions, ordering medications, etc.

Abundant data, on the other hand, is useless without a mechanism to access, analyze, arrange, and present it for consumption by a user. Moreover, data alone cannot help a pharmacy improve its performance. For example, knowing that you should be increasing your customer base is not informative as to how to do so.

Accordingly, apparatuses and methods are provided that can acquire benchmarking data regarding a particular performance metric, compare a pharmacy's performance with the performance of other pharmacies using the benchmarking data, and recommend action plans aimed at improving the pharmacy's performance. The action plans may be customized for the particular pharmacy, so as to provide the pharmacy with a detailed, pharmacy-specific recommendation for improving performance in one or more targeted areas.

With reference to FIG. 1, a network environment 10 is shown that includes a user device 15, an application server 20, and various data repositories 25, 30, 35, 40, and 45 in communication with each other. The user device 15 may be a computer, such as a computer in a pharmacy with which a user (e.g., a pharmacist, technician, pharmacy director, etc.) may interact. The user device 15 may be configured to run various computer applications, such as a pharmacy benchmarking application that includes program code for carrying out certain functions as described in greater detail below. In some cases, the pharmacy benchmarking application may reside on the application server 20, and the user device 15 may be configured to access the application from the application server 20, such as over the Internet or other communications network. In this regard, the user device 15 may act as a web client, such as when the user accesses the benchmarking application residing on the application server 20 using a web-based interface configured to communicate with the application server over the network (e.g., the Internet). Alternatively or additionally, the user device 15 may include software that is configured to communicate with the application server 20 over a wired connection or wirelessly, such as via a network (e.g., the Internet). The application server 20 may be configured to support one or more applications, such as the benchmarking application described above.

Turning to FIG. 2, the user device 15, the application server 20, and/or components thereof may include or be embodied by an apparatus 60 comprising at least one processor 65 and at least one memory 70. The apparatus 60 may include or be in communication with a user input device 75, such as a keyboard, mouse, touchpad, etc., that is configured to receive input from a user and convey the input to the processor 65. In some embodiments, the apparatus 60 may further include or be in communication with a display 80 that is configured to present information to the user, as described below.

Referring again to FIG. 1, the application server 20 may be configured to communicate (e.g., over a network such as the Internet) with one or more data repositories 25, 30, 35, 40, 45. Each data repository may include a memory that is configured to store various types of information, and the application server 20 may be configured to request and receive data from one or more of the data repositories regarding various pharmacies and pharmacy transactions, as described in greater detail below.

As noted above, embodiments of the present invention provide an apparatus 60 for providing action plans for improving health care provider performance, shown in FIG. 2. The apparatus 60 may comprise at least one processor 65 and at least one memory 70. The at least one memory 70 and the computer program code may be configured to, with the processor, cause the apparatus 60 to at least receive selection from the user of one of a plurality of predefined performance metrics, analyze a performance of the health care provider with respect to benchmarking data for the metric selected, and provide for presentation to the user of a recommended action plan based on the metric selected. In some cases, the at least one memory and the computer program code may be further configured to, with the processor, cause the apparatus to receive selection from the user of a benchmarking location grouping, and to access benchmarking data for analysis based at least partially on the benchmarking location grouping selected. For example, the benchmarking location grouping may be a predefined grouping of other pharmacies that the user wishes to include in the analysis of the pharmacy associated with the user, as described below.

Turning to FIG. 3, for example, the apparatus may cause a user interface 100 to be presented to the user (e.g., via the display 80 of FIG. 2 of the user device 15 of FIG. 1) that lists various benchmarking location groupings 110 from which the user may select a desired grouping. The benchmarking location groupings may include groupings of pharmacies by District (e.g., a defined population of stores, as defined by the user and stored on the application server 20); Region (e.g., a defined population of Districts, as defined by the user and stored on the application server); Area (e.g., a defined population of Regions, as defined by the user and stored on the application server); chain (e.g., a population that includes all defined Areas and thus includes all individual stores in those areas, such as the entire chain of associated stores or pharmacies); zip code; metropolitan statistical area (MSA) (e.g., as defined by the U.S. Office of Management and Budget (OMB) and used by the U.S. Census Bureau and other federal government agencies for statistical purposes); state; country; or custom geographic segment.

In this regard, the custom geographic segment may be a user-defined grouping based on a combination of two or more of the system-defined groupings described above. An example of a simple custom geographic segment may be a combination of several states or zip codes. For example, a pharmacy located on a state border may find it more useful to compare its performance with other pharmacies in two states (state A+state B), rather than only in the state in which it is located due to its border location. Thus, a pharmacy located on the border between North Carolina and South Carolina may specify a benchmarking location grouping of both North and South Carolina to get a more accurate picture of its performance as compared to its peers. A more advanced example of a custom geographic segment may be where the user wishes to compare its pharmacy with those in several states (e.g., Texas and Oklahoma), while excluding certain zip codes. Any available standard system-defined geographic segment may be used in logical combinations (e.g., using operators such as and, or, xor, not, greater than, less than, equals etc.). Selection of a benchmarking location grouping by the user thus provides a group of pharmacies from which benchmarking data may be acquired, as described in greater detail below.

As mentioned above, the apparatus may be caused to receive selection from the user of one of a plurality of predefined performance metrics. For example, the apparatus may be caused to present (e.g., upon the display 80 of FIG. 2 of the user device 15 of FIG. 1) a user interface 120, as shown in FIG. 4A. The user interface 120 may display a list of predefined performance metrics 130, from which the user may select a metric to be considered in the analysis of the health care provider's performance. A description of each of the performance metrics shown in the example listing of FIG. 4A is provided in Table 1, below.

TABLE 1

| Performance Metric Label | Description |
|---|---|
| RxFill Total Count | The total number of prescriptions filled |
| New Rx % | The percentage of prescriptions filled that are |
| | new prescriptions |
| Refill Rx % | The percentage of prescriptions filled that are |
| | refill prescriptions |
| Electronic Prescription Total Count | The total number of prescriptions filled having |
| | an e-prescribing origin |
| Electronic Prescription NEWRX Count/% | The total count of prescriptions filled having |
| | an e-prescribing origin that are new |
| | prescriptions along with the percentage of |
| | those compared to all prescriptions from any |
| | origin |
| Electronic Prescription REFRES-A Count/% | The total count of prescription renewals (refill |
| | request approvals) received along with the |
| | percentage of those compared to all |
| | prescription renewal requests (refill requests) |
| | made |
| Electronic Prescription Controlled Substance | The total number of prescriptions filled having |
| Count/% | an e-prescribing origin that are controlled |
| | substances along with the percentage of those |
| | compared to all controlled substances |
| | prescriptions filled |
| Electronic Prescription | The total number of prescriptions filled |
| Top Prescriber Count/% | showing count and percentage by the top |
| | prescribers (e.g., practice group or doctor) |
| | from an e-prescribing origin |
| Electronic Prescription Controlled Substance | The “Electronic Prescription Controlled |
| Top Prescriber Count/% | Substance Count/%” metric described above |
| | by the top prescribers |
| RxFill-OriginCode-X Count/% | The count and percentage of total prescriptions |
| | filled by the various standard pharmacy claim |
| | Origin Codes (e.g., e-prescribing vs. walk-in |
| | vs. fax) compared to all prescriptions filled |
| RxFill-Drug Specific Count/% | The count and percentage of total prescriptions |
| | filled by drug (e.g., Atorvastatin, etc.) |
| RxFill-Drug Class Specific Count/% | The count and percentage of total prescriptions |
| | filled by drug class (e.g., statins, etc.) |
| RxFill-Payer Specific Count/% | The count and percentage of total prescriptions |
| | filled by Payer (e.g., payer of the claim, a |
| | specific pharmacy benefit plan by the various |
| | standard pharmacy claim Bank Identification |
| | Number-BIN Processor Control Number-PCN) |
| RxFill-Payer Type Count/% | The count and percentage of total prescriptions |
| | filled by Payer Type (e.g., Medicare, Medicaid, |
| | Commercial, Workers Compensation, etc.) |
| RxFill-VerificationReject-X Count/% | The count and percentage of total prescriptions |
| | rejected by reject reason compared to the total |
| | prescriptions filled, such as using prescription |
| | reject data from the pharmacy management |
| | system, where the pharmacist may have the |
| | ability to verify and approve or reject the |
| | prescription before dispensing to the patient |
| | (e.g., for wrong quantity counted, wrong drug, |
| | wrong patient, etc.). This is an example of a |
| | key pharmacy quality and safety metric. |
| Custom Metric | A user-specified metric |

As shown in FIG. 4A and Table 1, the user may, in some embodiments, have the option of specifying a custom metric. The custom metric may be, for example, a combination of existing metrics and/or data, such as the percentage of total prescriptions filled by origin and the percentage of total prescriptions that were rejected by the pharmacist during the verification step in their dispensing process as captured by their pharmacy management system. An example of a custom metric may be a simplified view of a standard, system-defined metric, such as the Electronic Prescription NEWRX % (e.g., showing the percentage without the “count” statistic). As another example, a custom metric may exclude outlying data, such as any data that has a value greater than three times the pharmacy's value for the metric.

Benchmarking data (e.g., data from other pharmacies, such as pharmacies in the specified benchmarking location grouping described above) for the selected metrics may be reported over some interval of time, which may be user-defined or selected by the user from a list of standard, system-defined intervals. Examples of system-defined time intervals may include last year, year-to-date (YTD), trailing twelve months (TTM), trailing six months (T6M), trailing three months (T3M), last month, month-to-date (MTD), last week, week-to-date (WTD), and yesterday, to name a few.

The user may thus select a performance metric 130 according to what the user believes is important to the pharmacy. For example, the user may select to view data regarding the percentage of prescriptions filled via e-prescribing systems that are refill prescriptions in an effort to see if the pharmacy is losing customers to other pharmacies or mail-order pharmacies (e.g., if the pharmacy's statistics indicate that the percentage of refill prescriptions is dropping or is less than it is for other pharmacies in the benchmarking location grouping selected). As a different example, the user may select to view data regarding the percentage of total prescriptions filled by payer type volume in preparation for negotiating a contract with a payer (e.g., to see how much business the pharmacy has had with a particular payer in the past and compare it to how much business others may have with the payer) or as a way to prepare for an audit, for example.

In some embodiments, the at least one memory and the computer program code may be further configured to, with the processor, cause the apparatus to monitor the performance of the health care provider for the metric selected over a predefined period of time. For example, the user may have the option of putting a selected performance metric into a “tracking” mode for his/her pharmacy to be able to easily monitor the progress of the pharmacy with the particular metric over time. Such a tracking mode may allow the user to automatically see how it has done and/or how the pharmacy is trending with respect to other pharmacies for the specified metric. In some cases, the pharmacy may be able to track one or several metrics. For example, the pharmacy may set up a “business scorecard” via the benchmarking application and may be able to track its progress for certain metrics using the business scorecard. In this way, the pharmacy may be able to monitor its metrics indefinitely before invoking an action plan on any metric (as described below). This may be the case, for example, in a situation in which the pharmacy has strong performance on all its select metrics (and, thus, has no particular need for an action plan at that time). In other cases, however, the pharmacy may see performance issues that it wants to improve and may begin initiating associated action plans for improving one or more of the metrics.

Accordingly, the memory and the computer program code may be further configured to, with the processor, cause the apparatus to analyze performance of the health care provider with respect to benchmarking data for the metric selected. The benchmarking data may, in some cases, be accessed from at least one third party source. For example, with reference to FIG. 1, the application server 20 may be configured to communicate with various data repositories 25, 30, 35, 40, 45, and each data repository may store information related to one or more particular aspects of pharmacy performance.

One of the data repositories 25 may, for example, store information relating to transactions involving the user's pharmacy (e.g., data relating to one or more of the metrics listed in Table 1 with respect to the user's pharmacy), such as the number of prescriptions filled, the names and classes of drugs involved, the method of prescribing (e.g., e-prescribing vs. walk-in), etc. As such, in some cases, the data repository 25 may be a memory of the user device 15.

Another data repository 30 may be a memory or database covering a network of pharmacies (e.g., pharmacies affiliated with the same chain of retail stores) and may, likewise, store information relating to transactions involving the affiliated pharmacies.

Yet another data repository 35 that may be accessed by the application server 20 may be a commercial data aggregator, or third party entity configured to collect general market data from various entities in healthcare, including pharmacies, and make it commercially available to others.

Other examples of data repositories may include a data repository 40 belonging to a third party serving as a gateway for electronic prescribing. In this case, the third party may be a company that enables pharmacies to accept and fill electronic prescriptions by providing the framework and network structure to receive and process such prescriptions. Accordingly, the data repository 40 may be dedicated to storing information regarding the number of prescriptions that were electronically received and filled by subscribing pharmacies, and this information may be made commercially available to others (e.g., to subscribing organizations and pharmacies).

Still another example of a data repository may be a data repository 45 that is controlled by an information technology company that connects patients, providers, pharmacies, payers, and pharmaceutical manufacturers, such as a provider of revenue and payment cycle management and clinical information exchange solutions. Such a company may store data regarding the volume of claims (e.g., insurance claims) by drug manufacturer, method of payment (e.g., cash, Medicare, Medicaid, worker's compensation, etc.), name of drug, name of the prescriber, location of the prescription, etc., and may make it commercially available to others (such as the application server 20). This information may span more of the entire industry beyond the data immediately available from those health care providers using and making their data available to the apparatuses described herein.

In most cases, a particular pharmacy would opt in to share its data via one or more of the data repositories 25, 30, 35, 40, 45 described above. For example, a pharmacy that opts in to sharing its data through a data repository 40 that the pharmacy uses for its electronic prescribing needs may receive a discounted price for such services. Moreover, the data that is accessible to the application server 20 via one or more of the data repositories 25, 30, 35, 40, 45 may be provided in such a way as to maintain the source pharmacy's identity confidential. In this way, a pharmacy that chooses to share its information with others via one or more of the data repositories may do so without having its identity associated with the respective information.

In cases where the comparison group is small enough that the pharmacy or pharmacies used to obtain the benchmarking data are identifiable, an exception may be generated, and no data may be returned for analysis so as to promote fair, market-based competition and deter and avoid system abuse and potentially unfair practices, such as collusion or competitive isolation

Moreover, metrics that implicate Protected Health Information (PHI), as defined by the Health Insurance Portability and Accountability Act of 1996 (HIPAA), Public Law 104-191, under 45 CFR §160.103, or more stringent state laws, and which involve information about health status, provision of health care, or payment for health care that can be linked to a specific individual, may, in some cases, be allowed (e.g., defined by the user) as long as additional necessary and appropriate privacy/security controls and patient consent as applicable are in place to avoid or minimize the risk of a sensitive data breach. Examples of such metrics may include data regarding how much of the local diabetic population the user's pharmacy is serving as compared to other pharmacies and the associated trend.

As another example, advanced metrics may allow a pharmacy to compare specific outcomes against those of other pharmacies. For example, a metric may provide information regarding how well a pharmacy's new diabetic patients are controlling their HbAlc (i.e., a measure of diabetic control, specifically glycated hemoglobin) as compared to the national average. Such an inquiry may provide strong objective bargaining power to a pharmacy engaging in contract negotiations with Accountable Care Organizations or other quality/performance-based Provider/Payer networks. FIG. 4B shows one example of a Performance Benchmark Report with respect to the metric “RxFill-Payer Specific Count,” in which the prescription count for the user (“you”) is plotted in comparison to a benchmark for the months of January through August.

In some embodiments, the benchmarking data accessed by the application server 20 as described above may be aggregated and arranged using specific algorithms according to defined rules. For example, Top Prescriber metrics above may be limited to the top 200 prescribers, thus making the information easier for the user to digest. In some cases, the data processing algorithms may be run as the data is collected (e.g., accessed from the data repositories). This may occur, for example, in cases where the user requests to see metrics that are analyzed over a predefined interval of time (e.g., YTD, last month, etc.). Accordingly, analysis of the performance of the health care provider with respect to benchmarking data may occur in real time, such that the data is analyzed upon user request. Accordingly, although the specific format and/or content of the reports that are generated may vary, the reports should include the very latest data available within the capabilities of the computing power available on the servers involved in the processing.

As noted above, embodiments of the invention provide for identification and presentation to the user of a recommended action plan based on the metric selected and/or the analysis that is performed. This link between metric and action plan may be established by administrators of the apparatus described herein and/or by users, as described below. In particular, according to one embodiment, one or more action plans may be predefined and stored in the memory associated with the application server and/or user device. Each action plan may further be associated with one or more metrics, wherein the memory may further store a linking of actions plans to their corresponding metric(s). Each action plan may be assigned to one or multiple metrics and, similarly, each metric may be assigned to one or multiple predefined action plans.

Upon analysis of the benchmarking data associated with a selected metric, the memory and the computer program code may be configured to cause the apparatus to identify the one or more predefined actions plans associated with the selected metric. The at least one memory and the computer program code may then be further configured to, with the processor, cause the apparatus to provide for presentation to the user of the recommended action plan(s) by providing for presentation to the user of the one or more identified predefined action plans based on the metric selected and/or the analysis that is performed. Example user interfaces 150 which may be displayed (e.g., on a display 80 of FIG. 2 of the user device 15 of FIG. 1) are shown in FIGS. 5A and 5B. Accordingly, the apparatus may be caused to receive selection from the user of one of the action plans for execution.

In the depicted example of FIG. 5A, the user is presented with four suggested action plans 160 from which to choose: (1) Create Mail-Merge for Print; (2) Queue up for Outbound Call/Autodial; (3) Initiate Consulting; (4) Download File. In essence, each action plan 160 may be viewed as a tool that the user may use to help improve performance of the pharmacy in one or more areas. The improvements may be driven at the store or chain level, or they can be value-added services offered by a third party vendor (such as an entity associated with the application server 20) or a business partner.

As noted above, action plans 160 may be based on the metric selected by the user and/or on the analysis performed. In some cases, one or more of the metrics may not be associated with a defined action plan. For example, a specific action plan may not be defined for the metric RxFill Total Count because the opportunity and target audience may be too vague to automate. In other words, such a metric may be too general and may implicate too many variables to lend itself to a particular action plan for improving performance. As a counter example, however, the metric Electronic Prescription NEWRX count/% may be associated with an action plan to contact the pharmacy's current, most significantly declined electronic prescribers using the Queue up for Outbound Call/AutoDial action plan.

In this regard, in some embodiments, the at least one memory and the computer program code may be further configured to, with the processor, cause the apparatus to customize the action plan for the health care provider. Thus, in the example described above in which the action plan is to contact the pharmacy's current, most significantly declined electronic prescriber using the Queue up for Outbound Call/AutoDial action plan, the action plan may be automatically populated with the identity of the particular electronic prescribers and their contact information (e.g., phone number, contact name, transactional history, etc.). Moreover, a script may be provided as part of the action plan to help the caller (e.g., a pharmacy technician who is assigned to work the Outbound Call Queue) talk to the electronic prescribers to identify the pharmacy (e.g., by automatically filling in the pharmacy information as part of the script) and describe the reason for the call, with the intent that, as a result of the personal outreach, electronic prescribing volume may increase.

Accordingly, in some embodiments, the at least one memory and the computer program code may be further configured to, with the processor, cause the apparatus to receive an indication of acceptance of an action plan from the user and to execute the action plan in response to receipt of the indication. For example, the user may select (via the user input device 75 of FIG. 2 of the user device of FIG. 1) one of the action plans 160 presented as an action plan that the user accepts and wishes to initiate. In response, the user may be provided with instructions, documents, or other tools for executing the action plan.

For example, in selecting the action plan “Create Mail-Merge for Print,” the user may be presented with options for the mail-merge, such as Postal, Email, Export, or Other. Upon receiving the user's selection of one of the mail-merge options, a letter may be automatically populated with the pharmacy's information and information relating to, for example, the prescribers, facilities, and/or payers to whom it is suggested that the user reach out. Such a letter may, for example, state the pharmacy's appreciation for the prescriber's business, provide offers or incentives to motivate additional business, or simply express the desire to continue and grow the business relationship. The user may be requested to read the draft letter and authorize its sending to a certain group of the pharmacy's customers, and upon receiving such authorization, the application server 20 may direct that copies of the letter addressed to the appropriate individuals or medical groups be automatically printed out, put in envelopes, receive the appropriate postage, and be mailed out to the intended recipients. This may occur, for example, using a third party facilitator contracted by the owner of the application server, where the third party facilitator acts on behalf of the pharmacy to execute the action plan.

Another example action plan 160 may be to Initiate Consulting regarding how to improve the pharmacy's performance with respect to a particular metric. In this example, selecting the Initiate Consulting option may present the user with an option to engage a third party health care performance consultant. By agreeing to engage the consultant, the user may be committing to paying a certain amount in fees to the consultant or the consultant's agent (e.g., the entity controlling the application server). Accordingly, in receiving the acceptance of such terms, the action plan to Initiate Consulting may be automatically executed, and a consultant may be automatically requested to contact the user to discuss specific steps for improving the pharmacy's performance. As noted above, specific information regarding the pharmacy and its performance may be automatically submitted to the consultant in preparation for the meeting, such as the name and number of a contact for the pharmacy (e.g., the user), thereby tailoring the action plan to the specific user.

Yet another action plan 160 may be to Download a File. The file may range from generic information regarding the particular metric involved and how to improve Pharmacy performance in the selected field, or the file may be tailored to meet the particular needs of the pharmacy, such as by including information specific for the particular region in which the pharmacy is located or the size or type of the pharmacy, etc. Thus, in this example, the user's selection of this option may automatically execute the action plan by causing the action plan to be printed and/or otherwise provided to the user. Yet other examples of action plans may include the option to engage a plannogramming tool to improve product pick accuracy or an option to engage a reverse distributor to remove excess inventory. Many other types of action plans may also be provided.

In some embodiments, the user may be presented with options via the benchmarking application to manage the user's account and preferences and/or to manage action plans. For example, under a “Manage My Account and Preferences” menu, the user may be able to execute certain functions to control his or her account and key settings. The user may, for example, edit user passwords, manage users (e.g., give permission for other users to access the application, such as other pharmacy employees), edit demographic and default geographic segment information (e.g., how a user defines his or her preferences for Districts, Areas, Regions, MSA, home state, time zone, etc., view account balances (e.g., with respect to vendors and/or customers of the pharmacy), make payments (e.g., payments related to a consulting engagement entered into for executing a particular action plan), contact support (e.g., for help with the benchmarking application), cancel service (e.g., to discontinue use of the benchmarking application), set up automated reports and alerts (e.g., to receive reports or alerts regarding monitored performance metrics via email, phone, text, or instant messaging, etc.), download from/contribute to a community of action plans, etc.

In this regard, a “community” of action plans may be a managed set of potential improvements for a given metric. For example, with respect to the situation described above in which the pharmacy's performance for the metric Electronic Prescription NEWRX count/% has declined significantly, a “community” of action plans may include an action plan to contact the pharmacy's current, most significantly declined electronic prescriber (e.g., using the Queue up for Outbound Call/AutoDial function), as well as an action plan to contact top electronic prescribers in the benchmarking location grouping that have not been electronically prescribing with the user's pharmacy.

As noted above, the user may also have the option of managing action plans. In other words, through this option, the user may be able to tailor standard, system-defined action plans and/or create his or her own action plan for a given metric. Accordingly, the user may be able to view an action plan, create a new action plan, edit an existing action plan, and/or delete an action plan.

For example, as described above, one example of a simple action plan may be to provide a single document for the pharmacy staff to review as training. For example, a short slide presentation may be provided that includes Pharmacy Customer Service training materials referencing influential industry reports with factors to enhance success in pharmacy customer service. A user may feel it is helpful to link this particular action plan with a metric that can identify pharmacy sales significantly decreasing relative to other pharmacies in the selected benchmarking location grouping. As a result, any pharmacies that are tracking this metric and that select to improve their performance for this metric can view or download this action plan, such that they can view or download the presentation for use in their particular pharmacies.

For a more advanced action plan, such as one in which entire business services are provided to or hosted for the pharmacy, a live training seminar may be offered to the pharmacy that uses a professional consultant/expert speaking on pharmacy customer service. A user may choose to link this action plan with one or more performance metrics, such that any pharmacy selecting to improve their performance with this action plan would be presented with pricing, scheduling, and payment options for attending the live seminar.

In addition to considering general descriptions and associations with a given metric, a user may decide that a particular action plan would be most appropriate and effective for the pharmacy by looking at reviews and ratings submitted by other users that have previously engaged and completed the action plans with respect to the same or similar metrics. In some cases, potentially available metrics and/or action plans may be opened up as a “marketplace” where an entity associated with the application server may negotiate with business partners for paid advertising or placement of branded metrics and action plans.

Once an action plan has been published and is in use, edits and deletions of the action plan or portions of the action plan may be restricted based on any potential for adverse impact that may be expected due to the changes. In addition, users may have the opportunity to view and engage associated action plans based on their selected metrics (e.g., metrics they are monitoring). Action plan terms and conditions may be involved in some cases, which may range from non-specific, non-existent terms, to simple “click to accept” conditions, to offers to engage in extensive contract negotiations. Engaging an action plan may, in some cases, involve additional fees/pricing arrangements that may range from free (e.g., downloading a document) to thousands of dollars (e.g., engaging a personal consultant). Moreover, the fees may be one-time charges or recurrent (e.g., a monthly charge) based on the action plan and what products or services are being offered. In addition, entering into an action plan may be subject to different timing and availability, which may range from immediate download to a scheduled future event or service. The action plan may be provided as a service by a third party, such as the entity controlling and managing the application server, a party contracted by this entity, the pharmacy itself (such as in the case of self-service), or a combination thereof, as described above.

Referring to FIG. 6, embodiments of a method of providing action plans for improving health care provider performance are provided. According to embodiments of the method, selection from the user of one of a plurality of predefined performance metrics may be received at Block 200. Performance of the health care provider with respect to benchmarking data for the metric selected may be analyzed at Block 210, and presentation to the user of a recommended action plan based on the metric selected may be provided for at Block 220. In some cases, presentation to the user of a plurality of predefined action plans may be provided for, and selection from the user of one of the action plans for execution may be received.

In some cases, the action plan may be customized for the health care provider at Block 230, as described above. An indication of acceptance of the action plan may be received from the user at Block 240, and the action plan may be executed (e.g., automatically executed) in response to receipt of the indication at Block 250.

In addition or alternatively, selection from the user of a benchmarking location grouping may be received at Block 260, and benchmarking data may be accessed for analysis at Block 270 based at least partially on the benchmarking location grouping selected. In this regard, the benchmarking data may be accessed from at least one third party source, such as a data repository as described above. Furthermore, analysis of the performance of the health care provider with respect to benchmarking data may occur in real time. In some cases, performance of the health care provider may be monitored for the metric selected over a predefined period of time.

Exemplary embodiments of the present invention have been described above with reference to block diagrams and flowchart illustrations of methods, apparatuses (e.g., systems) and computer program products. In some embodiments, certain ones of the operations above may be modified or further amplified as described below. Furthermore, in some embodiments, additional optional operations may be included, some examples of which are shown in dashed lines in FIG. 6. Modifications, additions, or amplifications to the operations above may be performed in any order and in any combination.

It will be understood that each operation, action, step and/or other types of functions shown in the diagram (FIG. 6), and/or combinations of functions in the diagram, can be implemented by various means. Means for implementing the functions of the flow diagram, combinations of the actions in the diagrams, and/or other functionality of example embodiments of the present invention described herein, may include hardware and/or a computer program product including a computer-readable storage medium (as opposed to or in addition to a computer-readable transmission medium) having one or more computer program code instructions, program instructions, or executable computer-readable program code instructions stored therein.

For example, program code instructions associated with FIG. 6 may be stored on one or more storage devices, such as a memory 70 of the apparatus 60, and executed by one or more processors, such as processor 65, shown in FIG. 2. Additionally or alternatively, one or more of the program code instructions discussed herein may be stored and/or performed by distributed components, such as those discussed in connection with the apparatus 60. As will be appreciated, any such program code instructions may be loaded onto computers, processors, other programmable apparatuses or network thereof from one or more computer-readable storage mediums to produce a particular machine, such that the particular machine becomes a means for implementing the functions of the actions discussed in connection with, e.g., FIG. 6 and/or the other drawings discussed herein. As such, FIG. 6 showing data flows may likewise represent program code instructions that may be loaded onto a computer, processor, other programmable apparatus or network thereof to produce a particular machine.

The program code instructions stored on the programmable apparatus may also be stored in a nontransitory computer-readable storage medium that can direct a computer, a processor (such as processor 65) and/or other programmable apparatus to function in a particular manner to thereby generate a particular article of manufacture. The article of manufacture becomes a means for implementing the functions of the actions discussed in connection with, e.g., FIG. 6. The program code instructions may be retrieved from a computer-readable storage medium and loaded into a computer, processor, or other programmable apparatus to configure the computer, processor, or other programmable apparatus to execute actions to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel by one or more machines, such that multiple instructions are retrieved, loaded, and/or executed together. Execution of the program code instructions may produce a computer-implemented process such that the instructions executed by the computer, processor, other programmable apparatus, or network thereof provides actions for implementing the functions specified in the actions discussed in connection with, e.g., the process illustrated in FIG. 6.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, although the description above makes reference to benchmarking in the context of a health care provider's business, such as a pharmacy, it is understood that the embodiments described may be applicable to any type of business in any field. Although specific terms are employed herein, they are used in a generic and descriptive sense only and not for purposes of limitation.

What is claimed is:

1. An apparatus for providing action plans for improving health care provider performance, the apparatus comprising at least one processor and at least one memory including computer program code, the at least one memory and the computer program code configured to, with the processor, cause the apparatus to at least:
receive selection from a user of one of a plurality of predefined performance metrics;
analyze performance of a health care provider with respect to benchmarking data for the metric selected; and
provide for presentation to the user of a recommended action plan based on the metric selected and the performance of the health care provider.

2. The apparatus of claim 1, wherein the at least one memory and the computer program code are further configured to, with the processor, cause the apparatus to provide for presentation to the user of the recommended action plan by providing for presentation to the user of a plurality of predefined action plans based on the metric selected, wherein the at least one memory and the computer program code are further configured to, with the processor, cause the apparatus to receive selection from the user of one of the predefined action plans for execution.

3. The apparatus of claim 1, wherein the at least one memory and the computer program code are further configured to, with the processor, cause the apparatus to customize the action plan for the health care provider.

4. The apparatus of claim 1, wherein the at least one memory and the computer program code are further configured to, with the processor, cause the apparatus to receive an indication of acceptance of the action plan from the user and to execute the action plan in response to receipt of the indication.

5. The apparatus of claim 1, wherein the at least one memory and the computer program code are further configured to, with the processor, cause the apparatus to receive selection from the user of a benchmarking location grouping, and to access benchmarking data for analysis based at least partially on the benchmarking location grouping selected.

6. The apparatus of claim 1, wherein the at least one memory and the computer program code are further configured to, with the processor, cause the apparatus to access the benchmarking data from at least one third party source.

7. The apparatus of claim 1, wherein the at least one memory and the computer program code are further configured to, with the processor, cause the apparatus to monitor the performance of the health care provider for the metric selected over a predefined period of time.

8. The apparatus of claim 1, wherein the analysis of the performance of the health care provider with respect to benchmarking data occurs in real time.

9. A method for providing action plans for improving health care provider performance comprising:
receiving selection from a user of one of a plurality of predefined performance metrics;
analyzing, via a processor, performance of a health care provider with respect to benchmarking data for the metric selected; and
providing for presentation to the user of a recommended action plan based on the metric selected and performance of the health care provider.

10. The method of claim 9, wherein providing for presentation to the user of the recommended action plan comprises providing for presentation to the user of a plurality of predefined action plans based on the metric selected, the method further comprising receiving selection from the user of one of the predefined action plans for execution.

11. The method of claim 9 further comprising customizing the action plan for the health care provider.

12. The method of claim 9 further comprising receiving an indication of acceptance of the action plan from the user and executing the action plan in response to receipt of the indication.

13. The method of claim 9 further comprising receiving selection from the user of a benchmarking location grouping and accessing benchmarking data for analysis based at least partially on the benchmarking location grouping selected.

14. The method of claim 9 further comprising accessing the benchmarking data from at least one third party source.

15. The method of claim 9 further comprising monitoring the performance of the health care provider for the metric selected over a predefined period of time.

16. The method of claim 9, wherein the analysis of the performance of the health care provider with respect to benchmarking data occurs in real time.

17. A computer program product comprising at least one non-transitory computer-readable storage medium having computer-executable program code portions stored therein, the computer-executable program code portions comprising program code instructions for:
receiving selection from a user of one of a plurality of predefined performance metrics;
analyzing performance of a health care provider with respect to benchmarking data for the metric selected; and
providing for presentation to the user of a recommended action plan based on the metric selected and the performance of the health care provider.

18. The computer program product of claim 17, wherein the program code portions further comprise program code instructions configured for customizing the action plan for the health care provider.

19. The computer program product of claim 17, wherein the program code portions further comprise program code instructions configured for receiving selection from the user of a benchmarking location grouping and accessing benchmarking data for analysis based at least partially on the benchmarking location grouping selected.

20. The computer program product of claim 17, wherein the analysis of the performance of the health care provider with respect to benchmarking data occurs in real time.
